(19) United States
(12) Patent Application Publication
(10) Pub. No.: US 2005/0166704 A1
(43) Pub. Date: Aug. 4, 2005

(54) Bicycle handlebar clock mounting structure

(76) Inventor: Yuan-Hsin Huang, Yung Ching Hsiang (TW)

Correspondence Address: RABIN & BERDO, P.C., Suite 500, 1101 14th Street, N.W., Washington, DC, 20005, US

(21) Appl. No.: 10/831,123

(22) Filed: Apr. 26, 2004

(30) Foreign Application Priority Data
Jan. 30, 2004 (TW) 93201343

(51) Int. Cl. G05G 11/00

(52) U.S. Cl. 74/551.8

(57) ABSTRACT

A bicycle handlebar clock mounting structure installed onto the bar member comprising various different model handlebars. The clock mount is an inverted U-shaped construct and, furthermore, an end section extends inward from each of its two lateral extremities, an elongated adjustment hole is formed in each of the two end sections, and the center portion of the clock mount is of a regular tubular profile. A recessed arcuate surface fabricated along the underside of the clock enables sturdy positioning against the center portion of the clock mount. After screws are inserted through the adjustment holes in the end sections of the clock mount, the screws are tightened to attach various shape handlebars to the bicycle by means of clamp cover at the front end of the stem, enabling the clock mount to be widely utilized on a range of various style handlebars and thereby achieving clock installation practicality and convenience.

### BACKGROUND OF THE INVENTION

1) Field of the Invention

The invention herein relates to bicycle accessories, specifically a bicycle handlebar clock mounting structure that provides for clock installation on various model handlebars and thereby achieves installation practicality and convenience.

2) Description of the Prior Art

In the conventional installation of clocks on bicycle handlebars, since a recessed arcuate surface is typically fabricated along the underside the said clock, a double-sided adhesive plastic tape affixes it to the surface of the handlebar bar member. However, as the recessed arcuate surface under the clock only provides for attachment to handlebars having a regular tubular profile and existing handlebars are not only available in such consistent tubular profiles, when fitted on current designs of differently shaped handlebars, as indicated in FIG. 1-A and FIG. 1-B, the clock A cannot be fully mounted onto the surface of the said irregular tubular profile handlebar B such that when a bicycle so equipped travels over rough roads, the said clock A readily falls off due to insufficient surface area adhesion during continuous vibration.

In view of the said situation, the applicant of the invention herein sought improvements to address the said shortcomings that culminated in the successful development of the present invention which is submitted in application for patent rights.

### SUMMARY OF THE INVENTION

The primary objective of the invention herein is to provide a bicycle handlebar clock mounting structure that is installed onto the bar member comprising various different model handlebars in which the clock mount is an inverted U-shaped construct and, furthermore, an end section extends inward from each of its two lateral extremities, an elongated adjustment hole is formed in each of the two end sections, and the center portion of the clock mount is of a regular tubular profile; a recessed arcuate surface is fabricated along the underside of the clock enables sturdy placement against the center portion of the clock mount; after screws are inserted through the adjustment holes in the end sections of the clock mount, the screws are tightened to attach various shape handlebars to the bicycle by means of clamp cover at the front end of the stem, enabling the clock mount to be widely utilized on a range of various bend handlebars and thereby achieving clock installation practicality and convenience.

### BRIEF DESCRIPTION OF THE DRAWINGS

FIG. 1-A is an isometric drawing of the conventional structure when installed.

FIG. 1-B is an orthographic drawing of the installed conventional structure, as viewed from a lateral perspective.

FIG. 2 is an exploded drawing of the invention herein.

FIG. 3 is an isometric drawing of the invention herein after installation.

FIG. 4-A is an orthographic drawing of the invention herein at the installed position.

FIG. 4-B is a magnified drawing of the invention herein following installation.

FIG. 5 is an isometric drawing of the invention herein installed on another model handlebar.

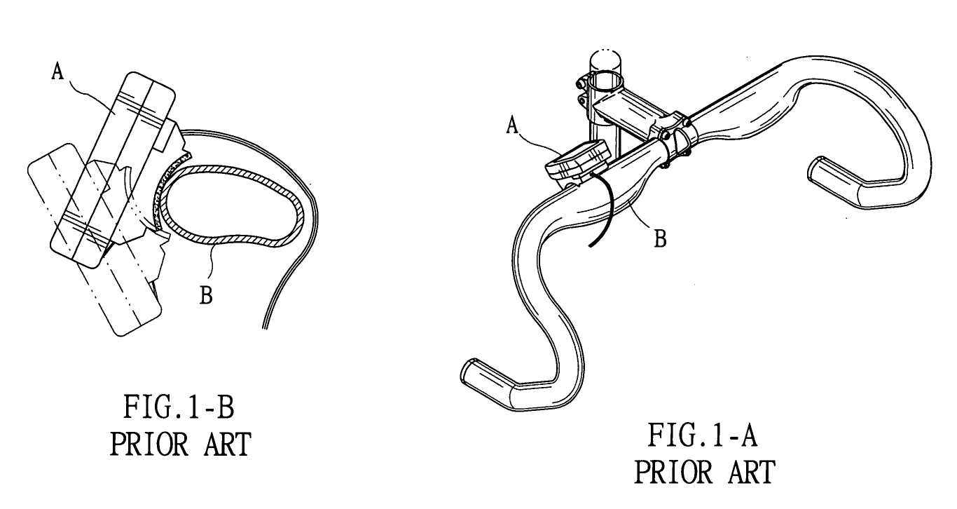

### DETAILED DESCRIPTION OF THE INVENTION

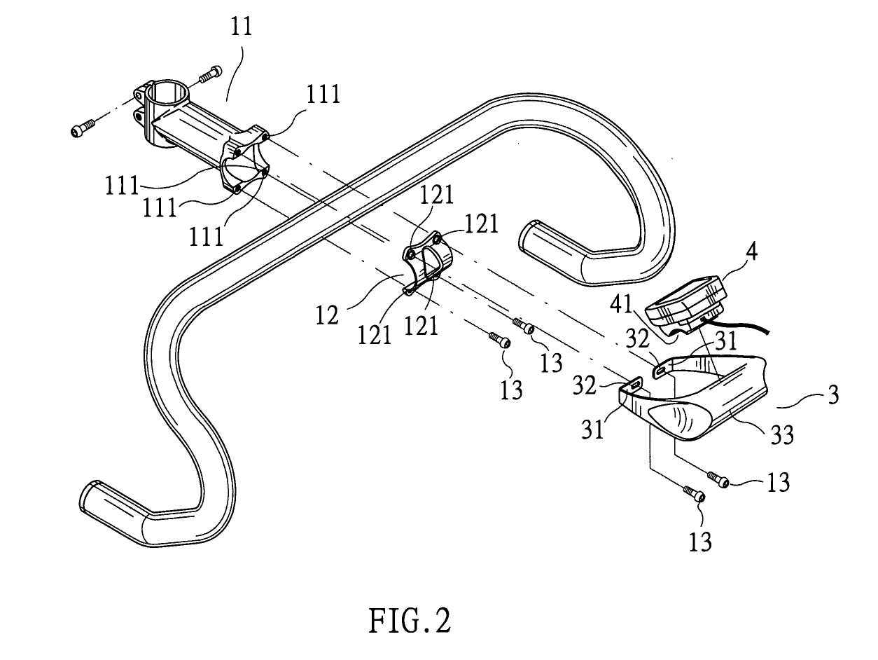

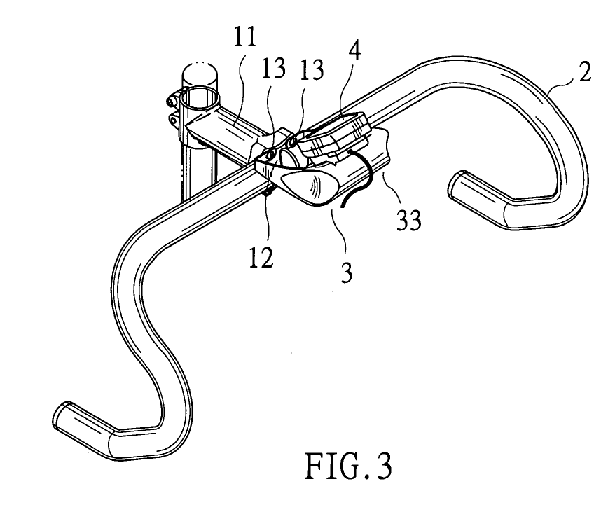

Referring to FIG. 2 and FIG. 3, the bicycle handlebar clock mounting structure of the invention herein is installed onto the anterior aspect of the bar member comprising various different model handlebars 2, the clock mount 3 is an inverted U-shaped construct and, furthermore, an end section 31 extends inward from each of its two lateral extremities, an elongated adjustment hole 32 is formed in each of the two end sections 31 and, furthermore, the center portion of the clock mount 3 is of a regular tubular profile 33; and a recessed arcuate surface 41 is fabricated along the underside of the clock 4.

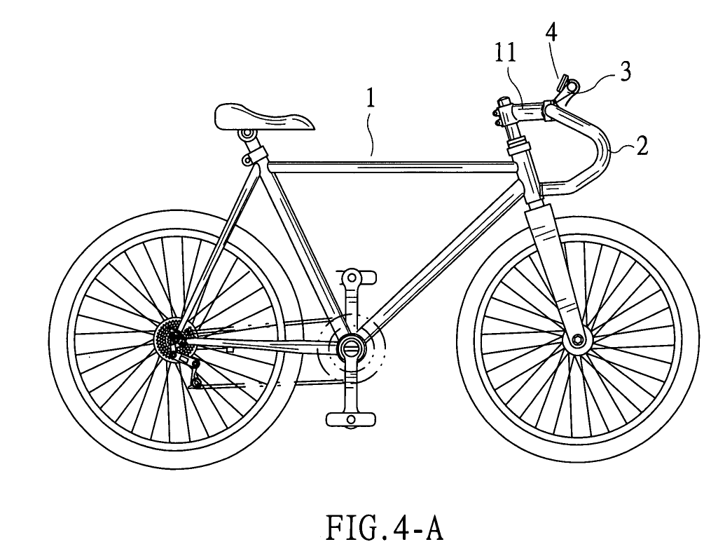

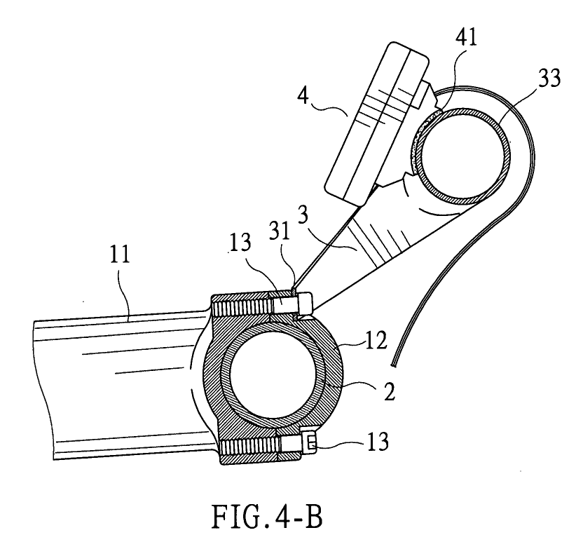

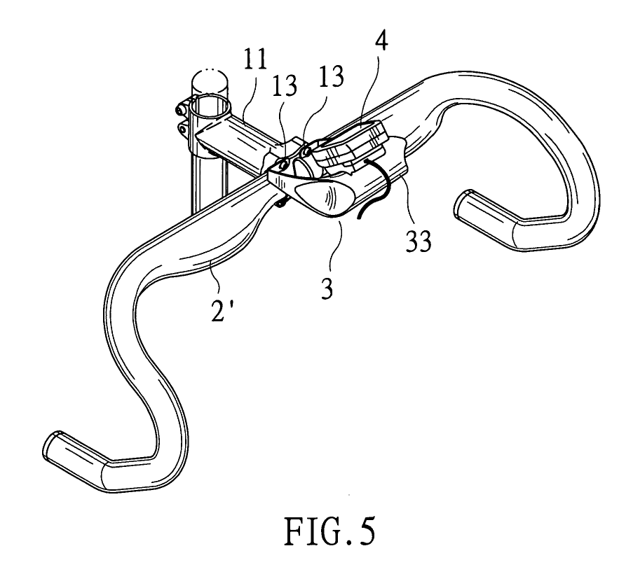

As such, when preparing to assemble various different style bend handlebars 2 and 2′ (as shown in FIG. 3 and FIG. 5) between the bicycle 1 stem 11 and clamp cover 12 (as shown in FIG. 4-A and FIG. 4-B), after the screws 13 for fastening together the stem 11 and the clamp cover 12 are first inserted through 121 holes of the clamp cover 12 as well as the adjustment holes 32 in the two end sections 31 of the clock mount 3, they are then tightened in the threaded holes 111 of the stem 11, thereby attaching handlebars 2 and 2′ of various shapes to the bicycle 1, while firmly positioning the clock mount 3, thereby reducing screw count and not affecting structural strength, following which the recessed arcuate surface 41 fabricated along the underside of the clock 4 is sturdily positioned against the tubular profile 33 surface at the center portion of the clock mount 3.

As a result, since the clock-4 is positively secured against the clock mount 3, the clock mount 3 is not affected by different style bend handlebars 2 and 2′, and is fully screw fastened to the bicycle frame, the said clock 4 is not dislodged by vibration when the host bicycle travels over rough roads.

In summation of the foregoing section, since the installation of the clock mount 4 of the invention herein is unaffected by dissimilarities among various different styles and shapes of handlebars, the present invention achieves installation practicality and convenience; as such, the invention herein has demonstrable utility and complies with the application requirements in Article 47 of the New Patent Law, the present invention is lawfully submitted to the patent bureau for review and the granting of the commensurate patent rights.

1. A bicycle handlebar clock mounting structure that is installed onto the anterior aspect of the bar member comprising various different model handlebars in which the clock mount is an inverted u-shaped construct and, furthermore, an end section extends inward from each of its two lateral extremities, an elongated adjustment hole is formed in each of the two said end sections and, furthermore, the center portion of the said clock mount is of a regular tubular profile; as such, when preparing to assemble various different style bend handlebar between the bicycle stem and clamp cover, after the screws for fastening together the said stem and the said clamp cover are first inserted through holes of the said clamp cover as well as the said adjustment holes in the said two end sections of the said clock mount and then tightened in the threaded holes of the said stem, a recessed arcuate surface fashioned along the underside of the clock is sturdily positioned against the said tubular profile surface at the center portion of the said clock mount and thus the clock mount can be widely utilized on a range of various shaped said handlebars, thereby achieving clock installation practicality and convenience.
